(19) United States
(12) Patent Application Publication
(10) Pub. No.: US 2024/0405365 A1
(43) Pub. Date: Dec. 5, 2024

(54) AN ASSEMBLY WITH NEGATIVELY CHARGED IONOMER MEMBRANE FOR AQUEOUS RECHARGEABLE ZINC METAL BATTERY

(71) Applicant: COUNCIL OF SCIENTIFIC AND INDUSTRIAL RESEARCH, New Delhi (IN)

(72) Inventors: Vidyanand VIJAYAKUMAR, Pune (IN); Arun TORRIS, Pune (IN); Maria KURIAN, Pune (IN); Meena GHOSH, Pune (IN); Manohar Virupax BADIGER, Pune (IN); Sreekumar KURUNGOT, Pune (IN)

(21) Appl. No.: 18/689,256

(22) PCT Filed: Aug. 26, 2022
(86) PCT No.: PCT/IN2022/050760

§ 371 Date: Mar. 5, 2024

(30) Foreign Application Priority Data
Sep. 5, 2021 (IN) 202111040210

(51) Int. Cl. H01M 50/414; H01M 4/50; H01M 10/26; H01M 10/42

(52) U.S. Cl. CPC H01M 50/414; H01M 4/50; H01M 10/26; H01M 10/4235; H01M 2300/0005

(57) ABSTRACT

The present invention relates to an assembly with a negatively charged dendrite inhibiting ionomer membrane made by cross-linking of sulfonated polyvinyl alcohol (PVS) and polyvinyl alcohol (PVA) for aqueous rechargeable zinc metal batteries (AZMBs).

### FIELD OF THE INVENTION

The present invention generally relates to the technical field of electrochemical energy storage/electrochemical energy conversion. Specifically, the present invention relates to an assembly with negatively charged ionomer membrane for aqueous rechargeable zinc metal battery. More particularly, the present invention relates to an assembly with negatively charged dendrite inhibiting ionomer membrane made by cross-linking of sulfonated polyvinyl alcohol (PVS) and polyvinyl alcohol (PVA) for aqueous rechargeable zinc metal batteries (AZMBs).

### BACKGROUND AND PRIOR ART OF THE INVENTION

Aqueous rechargeable zinc metal batteries (AZMBs) recently received widespread interest as a promising electrochemical energy storage technology. The AZMBs includes a metallic zinc (Zn) anode and a suitable cathode coupled in an aqueous electrolyte between which reversible shuttling of Zn²⁺ ions occur.

The deposition of high surface area zinc (HSAZ)/growth of Zn dendrite on the Zn-metal anode during cycling is a significant intricacy, which results in low cycling-stability of the aqueous rechargeable zinc metal batteries (AZMBs). There have been several attempts in the past dedicated to tackling the challenges mentioned above by tuning electrolytes, interphases, and separators.

For example, the article entitled “Dendrite Suppression Membranes for Rechargeable Zinc Batteries.” by Liu et al. published in the journal “ACS Applied Materials & Interfaces 2018, 10 (45), 38928-38935, DOI: 10.1021/acsami.8b14022” demonstrated the use of a polymeric cation exchange membrane based on cross-linked polyacrylonitrile, which allows homogenous distribution of Zn²⁺ ion flux at the electrode surface for suppressing the dendritic Zn deposition.

Another article entitled “An Interface-Bridged Organic-Inorganic Layer that Suppresses Dendrite Formation and Side Reactions for Ultra-Long-Life Aqueous Zinc Metal Anodes” by Cui et al. and published in the journal “Angewandte Chemie 2020, 132 (38), 16737-16744” proposed modification of Zn metal surface by an organic-inorganic hybrid interphase (based on the negatively charged Nafion ionomer and Zeolite). The hybrid interphase prevents all small molecules other than Zn²⁺ ions from reaching the Zn-metal surface, providing excellent interfacial stability by avoiding possible side reactions.

Similarly, the article entitled “Suppressing dendrite growth during zinc electrodeposition by PEG-200 additive” by Banik et al. and published in the journal “Journal of The Electrochemical Society 2013, 160 (11), D519” proved the positive effect of poly (ethylene glycol) (PEG)-based sacrificial surface protection layers against the Zn dendrite growth.

However, the AZMB full cell fabrication and cycling studies are missing in all the afore-mentioned reports. Other methods of surface modification of Zn metal include the coating with inorganic materials such as TiO₂, CaCO₃, carbon coating, and the use of concentrated electrolytes.

Recently, the article entitled “A universal and facile approach to suppress dendrite formation for a Zn and Li metal anode” by Cao et al. is published in the journal “Journal of Materials Chemistry A 2020, 8 (18), 9331-9344, DOI: 10.1039/D0TA02486D”. A glass-fiber separator modified with graphene oxide (GO) is used for suppressing Zn dendrite evolution in MnO₂∥Zn full cells. Although the GO-modified separator displayed good plating/stripping profiles, the rate-capability and specific capacity of the cell found to be inferior compared to several existing reports.

Yet another article entitled “Nafion lonomer-Based Single Component Electrolytes for Aqueous Zn/MnO₂ Batteries with Long Cycle Life” by Kurungot, S. et al. is published in the journal “ACS Sustainable Chemistry & Engineering 2020, 8 (13), 5040-5049, DOI: 10.1021/acssuschemeng.9b06798” and reported that conventional neutral separators such as polypropylene, glass-fiber, and filter-paper accelerate the dendritic Zn deposition in AZMBs. As an alternative, the potential of Zn²⁺-integrated Nafion™ (Sulfonated tetrafluoroethylene based fluoropolymer-copolymer) membrane for Zn dendrite suppression is reported. Despite the advantages, Nafion™ has disadvantages in terms of economic viability. Moreover, the water intake by Nafion™ at ambient conditions is inferior due to the hydrophobic characteristics of the PTFE backbone leading to low ionic conductivity. Therefore, it is essential to design Zn²⁺ conducting ionomer membranes superior to Nafion™ in better electrolyte intake, electrochemical properties, and processability.

Therefore, there is a need in the art to design Zn²⁺ conducting ionomer membranes as a superior alternative to other negatively charged ionomer membranes like Nafion™ for better electrolyte intake, electrochemical properties, and processability.

### OBJECTS OF THE INVENTION

The main objective of the present invention is to provide an assembly with economically viable negatively charged dendrite inhibiting ionomer membrane for aqueous rechargeable zinc-metal batteries (AZMBs).

Another objective of the present invention is to provide a negatively charged dendrite inhibiting ionomer membrane for aqueous rechargeable zinc-metal batteries (AZMBs).

Another objective of the present invention is to provide a process for the preparation of a negatively charged dendrite inhibiting ionomer.

### SUMMARY OF THE INVENTION

Accordingly, to accomplish the objectives, the present invention provides an assembly with economically viable negatively charged dendrite inhibiting ionomer membrane for aqueous rechargeable zinc-metal batteries (AZMBs). The assembly is made of a MnO₂ cathode, a Zn metal anode, aqueous ZnSO₄ electrolyte and a negatively charged dendrite inhibiting ionomer membrane.

In an embodiment, the present invention provides a negatively charged dendrite inhibiting and Zn²⁺ conducting ionomer membrane made by crosslinking of sulfonated polyvinyl alcohol (PVS) and polyvinyl alcohol (PVA) as a potential alternative to Nafion™ and neutral separators for aqueous rechargeable zinc-metal batteries (AZMBs).

In an aspect of an embodiment, a self-standing negatively charged ionomer membrane (P-AS-C) is prepared by the strategic cross-linking of the two polymers, named polyvinyl alcohol (PVA) and sulfonated polyvinyl alcohol (PVS). The resulting PVA-co-PVS copolymer membrane (P-AS-C) exhibits ionomer character due to the presence of sulfonate (SO₃⁻) groups evolved from PVS. Following a swelling process in an aqueous ZnSO₄ solution, the P-AS-C membrane becomes capable of conducting Zn²⁺ ions. Henceforth called P-AS-C—Zn membrane.

An electrochemical cell assembly for aqueous rechargeable zinc-metal batteries, the electrochemical cell assembly includes (a) a cathode (b) an anode (c) electrolyte and (d) a negatively charged dendrite inhibiting ionomer membrane. Wherein the negatively charged dendrite inhibiting ionomer membrane includes crosslinked sulfonated polyvinyl alcohol (PVS) with polyvinyl alcohol (PVA).

In another aspect of the present invention, the negatively charged dendrite inhibiting ionomer membrane of the electrochemical cell assembly conducts Zn²⁺ ions.

In another aspect of the present invention, the cathode of the electrochemical cell is MnO₂ cathode.

In another aspect of the present invention, the anode of the electrochemical cell is Zinc metal anode.

In another aspect of the present invention, the electrolyte of the electrochemical cell is aqueous ZnSO4.

In another aspect of the present invention, the negatively charged dendrite inhibiting ionomer membrane of the electrochemical cell is in a thickness of 100-500 μm.

In another aspect of the present invention, the electrochemical cell has a specific capacity of 330 mAh/g at a current density of 0.25 A/g.

In another aspect, the present invention relates to a negatively charged dendrite inhibiting ionomer membrane including crosslinked sulfonated polyvinyl alcohol (PVS) with polyvinyl alcohol (PVA), in a ratio range of 30:70 to 70:30.

In an aspect of an embodiment, a process for the preparation of negatively charged ionomer membrane (P-AS-C) is provided, wherein the process includes the steps of:
(a) dissolving 2 to 8 gms of PVA polymer in 70 to 90 mL of dry DMSO solvent at 70-95° C. for 30 to 90 mins;
(b) adding 0.5 to 2 gms of a base selected from potassium carbonate, sodium carbonate and lithium carbonate and 1 to 2 gms of propane sultone into the solution of step a) and refluxing for 10 to 20 hours;
(c) dialyzing obtained reaction mixture at step b) in a cellulose membrane against distilled water for 10 to 15 hours followed by removing excess water by distillation to afford yellow liquid;
(d) mixing 0.1 to 0.5 gms of PVS in 1 to 5 gms of aqueous solution of PVA and 1 to 5 gms of water;
(e) stirring the above mixture obtained at step d) for 20 to 30 hours and pouring into petri dish; and
(f) heating the above reaction mixture in hot air oven at 30 to 60° C. for 10 to 20 hours to obtain P-AS-C membrane.

In another aspect of the present invention, the process for the preparation of negatively charged ionomer membrane further comprises punching the P-AS-C membrane into small discs of radius 0.3 to 0.9 cm and subjecting the punched membrane to swelling in 0.5 to 2 M ZnSO₄. 7H₂O solution for 60 to 80 hours to ensure Zn²⁺ uptake.

In yet another aspect, the present invention relates to a negatively charged dendrite inhibiting ionomer membrane comprising of crosslinked sulfonated polyvinyl alcohol (PVS) with polyvinyl alcohol (PVA).

### BRIEF DESCRIPTION OF THE DRAWINGS

FIG. 1: ¹H NMR spectrum of the PVS polymer with peaks assigned.

FIG. 2: FTIR spectrum of the PVS polymer with peaks assigned.

FIG. 3: Photograph of the PVS solution after dialysis and purification.

FIG. 4: Scanning electron microscopy (SEM) images of (a) P-AS-C and (b) PVA-C membranes.

FIG. 5: (a) Energy Dispersive Spectroscopy (EDS) elemental mapping and (b) Energy Dispersive X-Ray Analysis (EDAX) of P-AS-C membrane.

FIG. 6: Tensile strength analysis of PVA-C and P-AS-C membranes.

FIG. 7: Swelling studies of P-AS-C and PVA-C membranes in aqueous solution of 1M ZnSO₄ (collected by considering the weight difference of membranes before and after soaking in the electrolyte solution for three days). The P-AS-C membrane displays high electrolyte intake compared to PVA-C counterpart.

FIG. 8: The Nyquist plots associated with (a) P-AS-C—Zn and (b) PVA-C—Zn membranes collected at the temperature range of 10 to 50° C.

FIG. 9: Various steps in the processing of Zn²⁺ conducting ionomer electrolyte membranes (P-AS-C—Zn). The crystallization-induced cross-linking of PVS and PVA polymers leads to a self-standing P-AS-C membrane. The P-AS-C membrane on swelling in aq. ZnSO₄ solution ensures the intake of Zn²⁺ ions. Hence formed P-AS-C—Zn membrane is used for the fabrication of the MnO₂|P-AS-C-Zn|Zn full cell.

FIG. 10: (a) The ln (σ) vs. 1000/T plot (Arrhenius plot) representing the change in ionic conductivity as a function of temperature; (b) the comparison of the CV profiles associated with the P-AS-C—Zn and PVA-C—Zn membranes in the SS∥Zn cell assembly; (c) Zn plating/stripping profiles of the P-AS-C—Zn and PVA-C—Zn membranes in the Zn∥Zn symmetric cells.

FIG. 11: The FESEM images of the Zn metal (working electrode) surface recovered from the (a), (b) Zn|P-AS-C-Zn|Zn and (c), (d) Zn|PVA-C-Zn|Zn cells; (e) XRD profile of the Zn metal (working electrode) surface recovered from the Zn|P-AS-C-Zn|Zn and Zn|PVA-C-Zn|Zn symmetric cells compared with that of pristine uncycled Zn.

FIG. 12: (a) and (b) FESEM images of the Zn (pristine) electrode at different magnifications.

FIG. 13: The comparison of the Nyquist plots recorded at OCV and 2^{nd} discharge of the (a) MnO₂|PVA-C-Zn|Zn and (b) MnO₂|P-AS-C-Zn|Zn cells. The associated Randles Equivalent Circuit model and the fit are also shown.

FIG. 14: (a) CV and (b) GCD profiles of the MnO₂|P-AS-C-Zn|Zn and MnO₂|PVA-C-Zn|Zn cells recorded at a scan-rate of 0.1 mV s⁻¹ and current density of 0.25 A g⁻¹, respectively; (c) rate performance and (d) cycling stability of the MnO₂|P-AS-C-Zn|Zn and MnO₂|PVA-C-Zn|Zn cells.

FIG. 15: CV profiles of (a) MnO₂|P-AS-C-Zn|Zn and (b) MnO₂|PVA-C-Zn|Zn recorded at various scan rates.

FIG. 16: GCD profiles of (a) MnO₂|P-AS-C-Zn|Zn and (b) MnO₂|PVA-C-Zn|Zn recorded at various current density values.

FIG. 17: Comparison of specific capacity of MnO₂|P-AS-C|Zn, MnO₂|treated Nafion™ |Zn, and MnO₂|untreated Nafion™|Zn cells at a current density of 0.25 A g⁻¹.

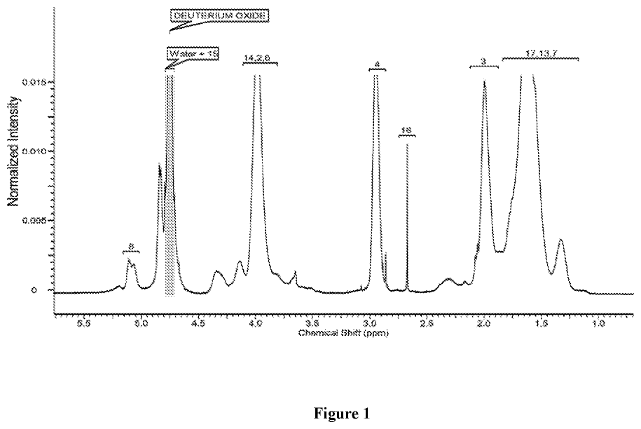

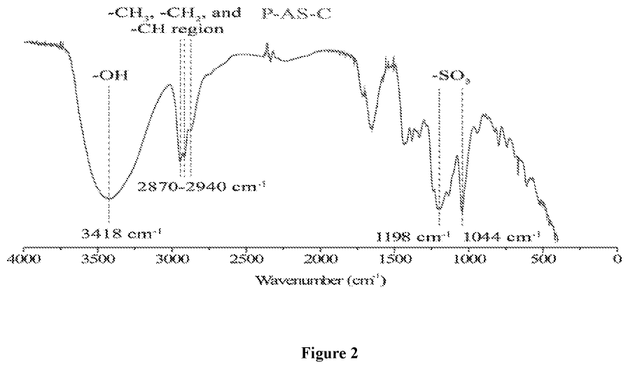

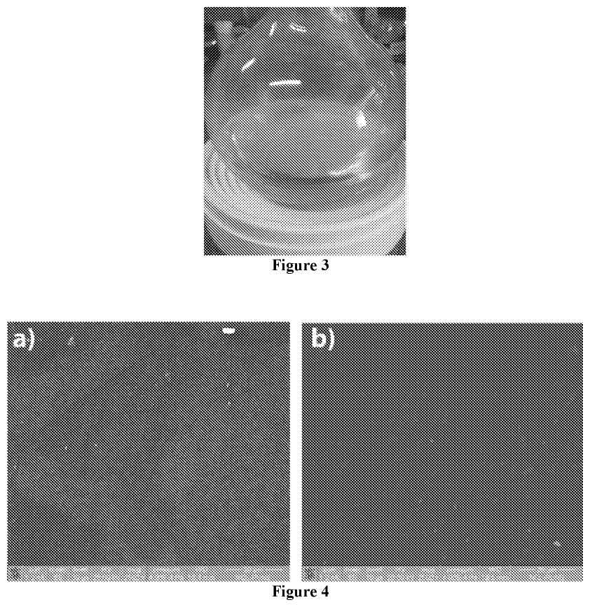

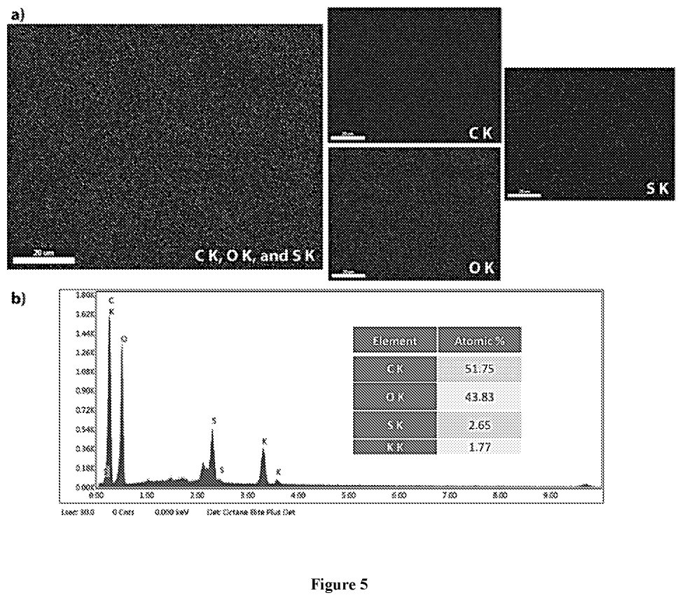

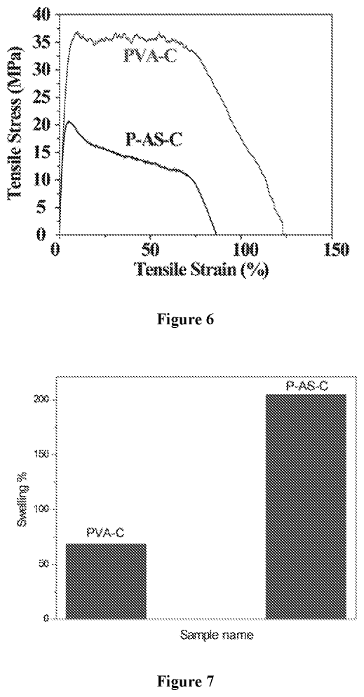

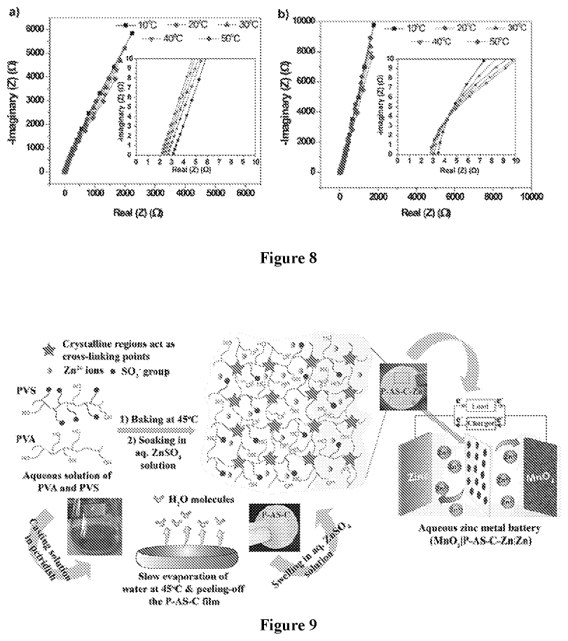

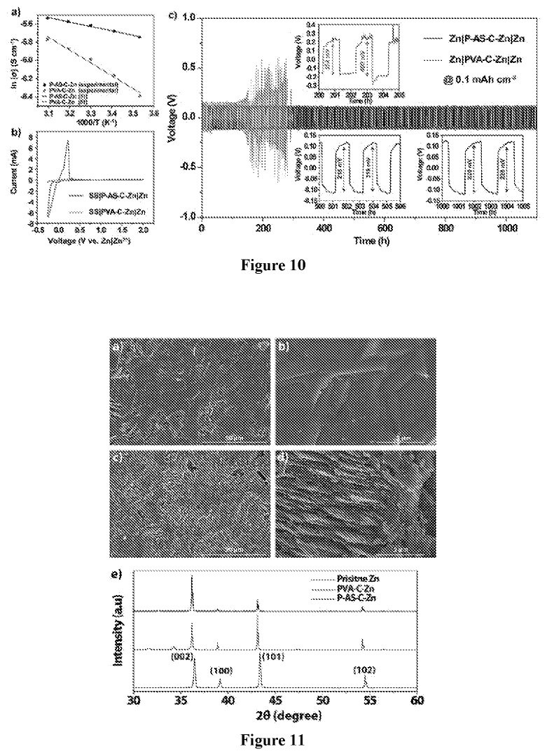

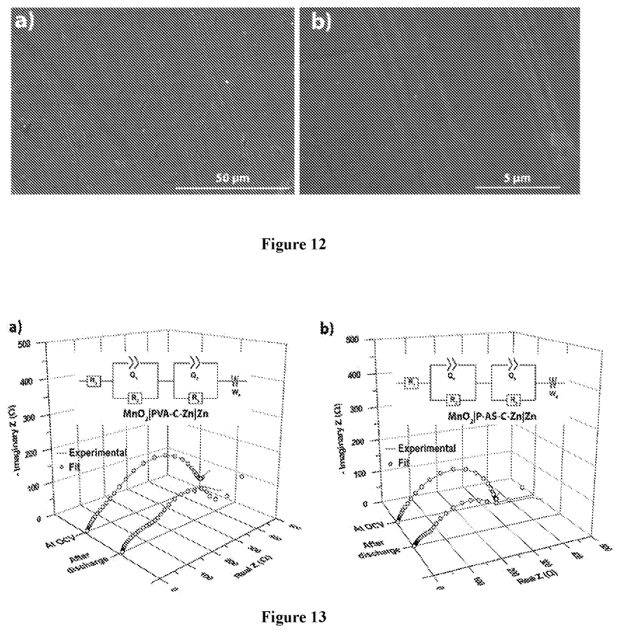

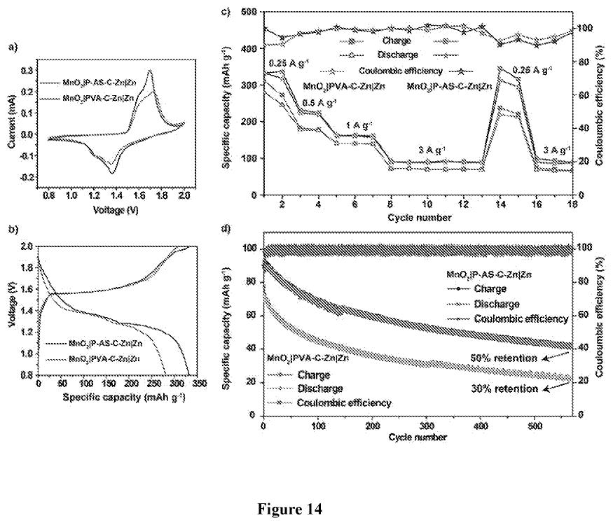

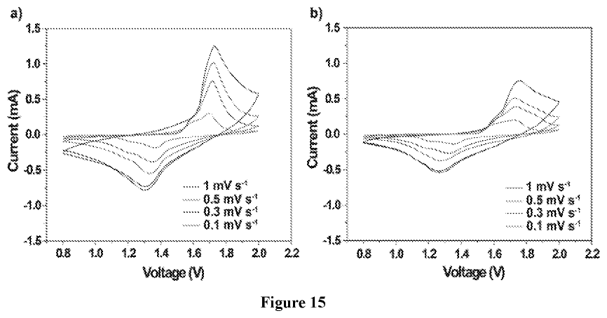

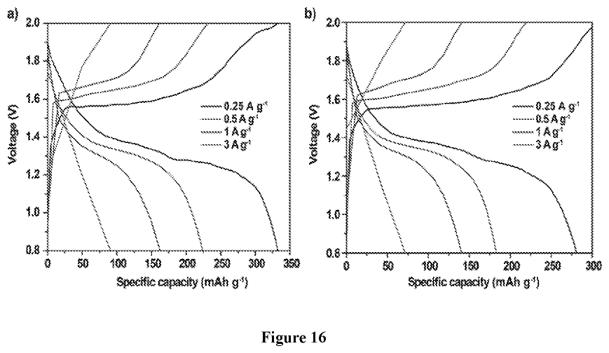

### DETAILED DESCRIPTION OF THE INVENTION

It is to be understood that the figures and descriptions of the present invention have been simplified to illustrate elements that are relevant for a clear understanding of the invention. The detailed description will be provided herein below with reference to the attached drawing.

The present invention provides an assembly with an economically viable and a negatively charged dendrite inhibiting ionomer membrane for aqueous rechargeable zinc-metal batteries (AZMBs). The assembly includes a MnO₂ cathode, a Zn metal anode, an aqueous ZnSO₄ electrolyte and a negatively charged dendrite inhibiting ionomer membrane.

In an embodiment, the present invention provides a negatively charged dendrite inhibiting and Zn²⁺ conducting ionomer membrane made by crosslinking of sulfonated polyvinyl alcohol (PVS) and polyvinyl alcohol (PVA) as a potential alternative to Nafion™ and neutral separators for aqueous rechargeable zinc-metal batteries (AZMBs).

In an aspect of an embodiment, a self-standing negatively charged ionomer membrane (P-AS-C) is prepared by the strategic cross-linking of the two polymers, named polyvinyl alcohol (PVA) and sulfonated polyvinyl alcohol (PVS). The resulting PVA-co-PVS copolymer membrane (P-AS-C) exhibits ionomer character due to the presence of sulfonate (SO₃⁻) groups from PVS. Following a swelling process in an aqueous ZnSO₄ solution, the P-AS-C membrane becomes capable of conducting Zn²⁺ ions.

In an aspect of an embodiment, a process for the preparation of negatively charged ionomer membrane (P-AS-C) is provided, wherein the process includes the steps of:
(a) dissolving 2 to 8 gms of polyvinyl alcohol (PVA) polymer in 70 to 90 mL of dry dimethyl sulfoxide (DMSO) solvent at 70-95° C. for 30 to 90 mins;
(b) adding 0.5 to 2 gms of a base selected from potassium carbonate, sodium carbonate and lithium carbonate and 1 to 2 gms of propane sultone into the solution of step a) and refluxing for 10 to 20 hours and a reaction mixture is obtained;
(c) dialyzing the obtained reaction mixture at step b) on a cellulose membrane against distilled water for 10 to 15 hours followed by removing excess water by distillation to afford yellow liquid;
(d) mixing 0.1 to 0.5 gms of sulfonated polyvinyl alcohol (PVS) in 1 to 5 gms of aqueous solution of PVA and 1 to 5 gms of water;
(e) stirring the above mixture obtained at step d) for 20 to 30 hours and pouring into a petri dish; and
(f) heating the above reaction mixture in a hot air oven at 30 to 60° C. for 10 to 20 hours to obtain P-AS-C membrane.

The afore-mentioned process is depicted below in scheme-1:

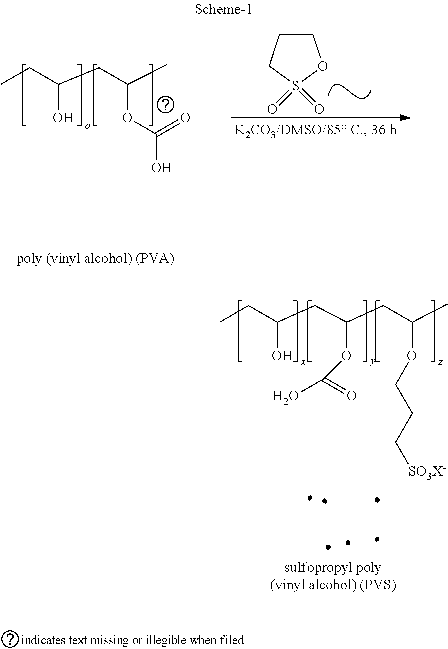

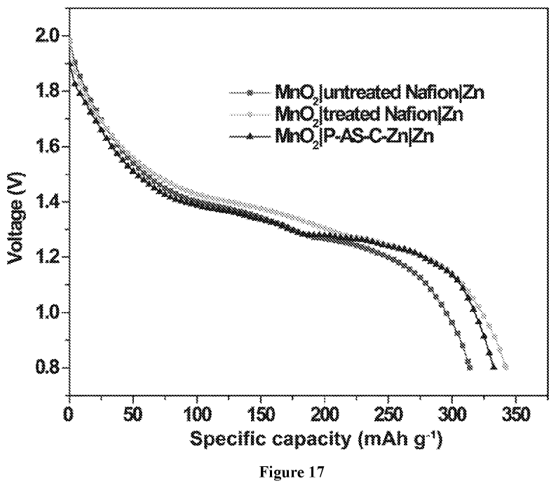

The specific capacity of the MnO₂∥Zn cells are compared with four different type of separators viz (1) Non-treated Nafion™, (2) pretreated Nafion™, (3) P-AS-C—Zn ionomer membrane, and (4) PVA-C—Zn membrane (non-ionomer). The specific capacity of the MnO₂∥Zn cells at a current density of 0.25 A/g is taken for comparison purpose. The comparison of specific capacity values is tabulated below in Table-1 (ref. FIG. 17).

TABLE 1

| | Pretreated | Nontreated | | |
|---|---|---|---|---|
| Parameter | Nafion ™ | Nafion ™ | P-AS-C-Zn | PVA-C-Zn |
| Specific | ≈340 mAh g⁻¹ | ≈315 mAh g⁻¹ | ≈330 mAh g⁻¹ | ≈280 mAh g⁻¹ |
| capacity at | | | | |
| 0.25 A g⁻¹ | | | | |
| Cycling | ≈60% retention | ≈60% retention | ≈50% retention | ≈30% retention |
| stability at | close to 600 | close to 600 | close to 600 | close to 600 |
| 3 A g⁻¹ | cycles | cycles | cycles | cycles |

From the above data, it is clear that the P-AS-C ionomer membrane has clear advantage over untreated Nafion™ in terms of specific capacity values. The hydrophilic hydrocarbon backbone of P-AS-C helps in better ion conduction compared to the hydrophobic fluorinated backbone in untreated Nafion™. The better performance of pretreated Nafion™ compared to non-treated Nafion™ could be due to the formation of more hydrophilic clusters as a result of the pretreatment step. The advantage of P-AS-C is that even without a pretreatment step, it can exhibit comparable performance similar to that of pretreated and non-treated Nafion™. Additionally, the processing of P-AS-C film is easy and cost-effective compared to Nafion™.

Moreover, in case of P-AS-C membranes, the backbone is a hydrocarbon chain unlike the perfluoroether chain in Nafion™. Therefore, the P-AS-C is more hydrophilic than Nafion™, which helps in the intake of more electrolyte compared to Nafion™ which can help in better ion conduction. Due to the hydrophilic nature of the P-AS-C membranes, even in the pre-treated state, the cluster formed by the hydrophilic domains will be more in P-AS-C. This provides superiority to the P-AS-C over Nafion™. The cycling stability of the AZMB cells with Nafion™ and P-AS-C—Zn membranes are more or less similar. By improving the processing of P-AS-C—Zn membranes, the thickness can be further reduced below 100 micrometers. This would help in the further improvement of the performance close to that of Nafion™ membranes.

In an embodiment, the present invention relates to a negatively charged dendrite inhibiting ionomer membrane comprising of crosslinked sulfonated polyvinyl alcohol (PVS) with polyvinyl alcohol (PVA).

In another embodiment of the present invention, the negatively charged dendrite inhibiting ionomer membrane is hydrophilic in nature.

In another embodiment of the present invention, the negatively charged dendrite inhibiting ionomer membrane is in a thickness of 100 to 500 microns. Preferably, in thickness of 300 microns.

In an embodiment of the present invention, the sulfonated polyvinyl alcohol (PVS) and polyvinyl alcohol (PVA) in the negatively charged dendrite inhibiting ionomer membrane is present preferably in the range of 30:70 to 70:30 ratios; with a most preferred ratio of 50:50.

### Tensile Strength Measurements

P-AS-C membranes are punched into rectangular strips (5 mm width and 30 mm length), thickness is measured and loaded onto the tensile grips of pre-calibrated Universal Testing Machine (Model: 5943, Instron, Norwood, MA, USA), equipped with 1 kN load cell. Tensile measurements are performed in triplicate at a cross-head speed of 1 mm/min. Force and extension are recorded and plotted by Bluehill® II software.

### Zeta Potential Measurements

Aqueous solutions of PVS and PVA (0.1% w/v) are prepared and pH of these solutions are measured. Solutions are loaded onto transparent polystyrene cuvettes and zeta potential is measured in triplicate using a Zeta Potential Analyzer (Model: ZetaPALS, Brookhaven Instruments, USA).

### Electrochemical Characterizations

A BioLogic VMP3 Potentiostat is used for the electrochemical analysis such as cyclic voltammetry (CV) and electrochemical impedance spectroscopy (EIS). Neware BTS-4008-5V 10 mA is used for galvanostatic cycling of the fabricated cells. All the electrochemical cells are fabricated in CR2032 coin cell assembly. For the fabrication of MnO₂∥Zn full cells, a zinc metal foil (0.95 cm² area, 100 μm thick) is used as the negative electrode (anode) and electrodeposited MnO₂ as the positive electrode (cathode). The loading of MnO₂ in the electrode was ≈1 mg cm⁻². The P-AS-C—Zn or PVA-C—Zn membranes (thickness ≈300 μm, area ≈1.40 cm²) are used to prepare the MnO₂|P-AS-C-Zn|Zn and MnO₂|PVA-C-Zn|Zn cells, respectively. Similarly, Zn|P-AS-C-Zn|Zn and Zn|PVA-C-Zn|Zn cells are also fabricated for Zn plating stripping analysis at a current density of 0.1 mA cm⁻² for 1 hour (0.1 mAh cm⁻²).

For the ionic conductivity measurements, the membrane of interest is placed between two stainless steel (SS) spacers inside a CR2032 coin cell assembly and EIS measurements are carried out with a voltage amplitude of 10 mV between a frequency range of 1 MHz and 1 Hz at OCV. An ESPEC environmental chamber is used to control the temperature during the impedance measurement and the responses are recorded at every 10° C. interval (equilibrium is maintained by keeping the cell at each temperature for 30 min. during the measurement). From the bulk resistance obtained at each temperature, the ionic conductivity of the membranes is calculated by using Equation S1.

$$σ = {lA}^{- 1} {R}_{b}^{- 1} \qquad ( Equation S1 )$$

Here, ‘Rb’ is the bulk resistance, ‘1’ is the thickness, and ‘A’ is the area of the membrane.

EIS analysis of the MnO₂∥Zn full cells are carried out with a voltage amplitude of 10 mV between a frequency range of 1 MHz and 100 mHz at OCV, and an equilibrium potential of ≈0.8 V after the 2^{nd} discharge cycle. The CV of the full cells are recorded at scan-rates of 1, 0.5, 0.3, and 0.1 mV s⁻¹. The galvanostatic charge-discharge (GCD) profiles of the full cells are recorded at current density values of 0.25, 0.5, 1, 3 A g⁻¹. All the specific capacity values of the AZMB full-cells are normalized for the MnO₂ loading at the cathode. The CV of the P-AS-C—Zn and PVA-C—Zn membranes are recorded in SS∥Zn cells between a potential window of −0.25 to 2V vs. Zn|Zn²⁺ at a scan-rate of 0.5 mV s⁻¹ to understand the oxidation and reduction stability window.

### Material Characterizations

20 mg of PVS and 0.6 ml D₂O is transferred into NMR tube, mixed using vortex mixer. After dissolution, the ¹H NMR spectra is recorded using 400 MHz spectrometer (Model: Avance, Bruker, Germany). A drop of PVS is placed inside a KBr cell and loaded onto FTIR spectrometer (Model: Spectron One, PerkinElmer, Waltham, MA, USA). IR spectra of PVS is recorded and background is subtracted. For the electrochemical characterizations, BioLogic VMP3 potentiostat and Neware BTS-4008-5V 10 mA battery tester are used. An ESPEC environmental chamber is used to control the temperature during the impedance measurement. SEM images are collected using Quanta 200-3D. The Quanta 200-3D instrument equipped with an Energy-dispersive X-ray spectroscopy (EDX) detector is used for the Energy Dispersive Spectroscopy (EDS) elemental mapping and Energy Dispersive X-Ray Analysis (EDAX). The Nova Nano SEM 450 instrument is used for field emission scanning electron microscope (FESEM) analysis. The X-ray diffraction (XRD) analysis is carried out in a Rigaku, MicroMax-007HF instrument equipped with a high-intensity microfocus rotating anode X-ray generator (Cu Kα(α=1.54 Å)).

### EXAMPLES

Following examples are given by way of illustration and therefore should not be construed to limit the scope of the invention.

The materials used for the preparation of PVA-C and PAS-C membranes are poly(vinyl alcohol) (98 mol % hydrolyzed, from LOBA Chemie), 1,3-propane sultone (from Sigma Aldrich), potassium carbonate (from Merck) and dimethyl sulfoxide (from SD Fine Chemicals). Toray Carbon Paper was used as the current collector for the electrodeposition of MnO₂ was supplied by Global Nanotech, Mumbai. The salts Mn(OOCCH₃)₂ and (NH₄OOCCH₃) used for MnO₂ electrodeposition were purchased from Sigma Aldrich.

### Example 1: Electrodeposition of MnO₂

Electrodeposition of MnO₂ was carried out in a standard three-electrode cell assembly (ACS Sustainable Chemistry & Engineering 2020, 8 (13), 5040-5049, DOI: 10.1021/acssuschemeng.9b06798). For this purpose, Toray Carbon Paper (1 cm² area) was used as the working electrode, platinum mesh as the counter electrode, and platinum wire as the quasi-reference electrode. The electrodeposition bath contains 432 mg of Mn(OOCCH₃)₂ and 193 mg of (NH₄OOCCH₃) dissolved in 25 mL of deionized water. A constant current of 4 mA cm⁻² was applied at the working electrode to deposit ≈1 mg of MnO₂.

### Example 2: Preparation of P-AS-C—Zn Membrane

Ionomer characteristic was imparted to PVA by its sulfopropylation, achieved by the ring-opening reaction of propane sultone with PVA, resulting in the synthesis of sulfopropyl poly(vinyl alcohol) (PVS). Equi-molar ratios of PVA and propane sultone were used in the synthesis of PVS. Potassium carbonate was used to neutralize the sulfonic acid group formed during the homogeneous reaction. In a typical procedure, 5.0 g of PVA was dissolved in 80 ml dry DMSO solvent at 85° C. for 1 hour. 1 g of K₂CO₃ and 1.77 g of propane sultone was added and refluxed for 16 hours. After cooling, the products were dialyzed in a cellulose membrane against distilled water for 12 hours, followed by rota vaporization to remove excess water, resulting in a golden yellow liquid.

About 0.225 g of neat PVS is mixed with 2.25 g of 10% (w/v) PVA aqueous solution and 2.025 g of water. Mixture is stirred for 24 hours, poured into glass petridish (4.5 cm dia) and heated in a hot air oven at 45° C. for 12 hours, to obtain P-AS-C membrane. The peeled-off membranes were punched into small discs of radius ≈0.67 cm, and subjected to swelling in 1 M ZnSO₄. 7H2O solution for three days to ensure Zn²⁺ uptake. The tensile strength of ionomer membrane is in the range of 10 to 30 MPa with a water uptake capacity in the range of 150 to 200% of its dry weight.

### Example 3: Preparation of PVA-C—Zn Membrane

Following a similar procedure of example 2, PVA-C membrane was also prepared in the absence of PVS. The peeled-off membranes were punched into small discs of diameter ≈0.3 to 0.9 cm, and subjected to swelling in 0.5 to 2 M ZnSO₄. 7H2O solution for three days to ensure Zn²⁺ uptake.

### Advantages of the Invention

Sulfopropylated polyvinyl alcohol (PVS)-based Zn²⁺ conducting ionomer membranes are introduced first time as a potential alternative to Nafion™ and neutral separators for AZMBs.

A self-standing negatively charged ionomer membrane (P-AS-C) is prepared by the strategic cross-linking of the two polymers, named polyvinyl alcohol (PVA) and Sulfopropylated polyvinyl alcohol (PVS).

Anionic character of the membrane provides excellent Zn plating/stripping profile (stable over 1100 h. without failure), smooth Zn deposition, and high cycling stability (50% capacity retention over 500 cycles in MnO₂|P-AS-C-Zn|Zn full cells).

High specific capacity of ≈330 mAh g⁻¹ at a current density of 0.25 A g⁻¹, which is higher than the untreated Nafion™ counterpart.

We claim:

1. An electrochemical cell assembly for aqueous rechargeable zinc-metal batteries, the electrochemical cell assembly comprising:
(a) a cathode;
(b) an anode;
(c) electrolyte; and
(d) a negatively charged dendrite inhibiting ionomer membrane;
wherein the negatively charged dendrite inhibiting ionomer membrane comprises crosslinked sulfonated polyvinyl alcohol (PVS) with polyvinyl alcohol (PVA).

2. The electrochemical cell assembly as claimed in claim 1, wherein the negatively charged dendrite inhibiting ionomer membrane conducts Zn²⁺ ions.

3. The electrochemical cell assembly as claimed in claim 1, wherein the cathode is a MnO₂ cathode.

4. The electrochemical cell assembly as claimed in claim 1, wherein the anode is a Zinc metal anode.

5. The electrochemical cell assembly as claimed in claim 1, wherein the electrolyte is aqueous ZnSO₄.

6. The electrochemical cell assembly as claimed in claim 1, wherein the negatively charged dendrite inhibiting ionomer membrane is in a thickness of 100 to 500 microns.

7. The electrochemical cell assembly as claimed in claim 1, wherein cell has a specific capacity of 330 mAh/g at a current density of 0.25 A/g.

8. A negatively charged dendrite inhibiting ionomer membrane comprising of crosslinked sulfonated polyvinyl alcohol (PVS) with polyvinyl alcohol (PVA), in a ratio range of 30:70 to 70:30.

9. A process for the preparation of negatively charged dendrite inhibiting ionomer membrane (P-AS-C) comprising the steps of:
a) dissolving 2 to 8 gms of polyvinyl alcohol (PVA) polymer in 70 to 90 mL of dry dimethyl sulfoxide (DMSO) as a solvent at a temperature in the range of 70-95° C. for a time period of 30 to 90 mins;
b) adding 0.5 to 2 gms of a base selected from potassium carbonate, sodium carbonate and lithium carbonate and 1 to 2 gms of propane sultone into the solution of step a) and refluxing for 10 to 20 hours to obtain a reaction mixture;
c) dialyzing the reaction mixture obtained at step b) on a cellulose membrane against distilled water for a time period of 10 to 15 hours followed by removing excess water by distillation to afford yellow liquid;
d) mixing 0.1 to 0.5 gms of sulfonated polyvinyl alcohol (PVS) in yellow liquid of step c) in 1 to 5 gms of aqueous solution of polyvinyl alcohol (PVA) and 1 to 5 gms of water;
e) stirring the above mixture obtained at step d) for a time period of 20 to 30 hours and pouring it into a petri dish; and
f) heating the above reaction mixture in a hot air oven at a temperature of 30 to 60° C. for a time period of 10 to 20 hours to obtain the P-AS-C membrane material.

10. The process as claimed in claim 9, further comprises punching the P-AS-C membrane into small discs of radius 0.3 to 0.9 mm and subjecting the punched membrane to swelling in 1 M ZnSO₄·7H₂O solution for 72 hours to ensure Zn²⁺ uptake.
